(19) United States
(12) Patent Application Publication
(10) Pub. No.: US 2011/0080945 A1
(43) Pub. Date: Apr. 7, 2011

(54) APPARATUS AND METHOD FOR ADAPTING SCALABLE VIDEO CODING BITSTREAM

(75) Inventors: Truong Cong Thang, Daejeon (KR); Jung Won Kang, Daejeon (KR); Jeong Ju Yoo, Daejeon (KR); Jin Woo Hong, Daejeon (KR)

(73) Assignee: Electronics and Telecommunications Research Institute, Daejeon (KR)

(21) Appl. No.: 12/996,118

(22) PCT Filed: Jun. 4, 2009
(86) PCT No.: PCT/KR2009/002969

§ 371 Date: Dec. 3, 2010

(30) Foreign Application Priority Data
Jun. 5, 2008 (KR) 10-2008-0053241
Nov. 25, 2008 (KR) 10-2008-0117505

(51) Int. Cl. H04N 7/26

(52) U.S. Cl. 375/240.02; 375/E07.076

(57) ABSTRACT

An apparatus and method for adapting a scalable video coding (SVC) bitstream is provided. The apparatus may include: a layer selection unit to select at least one quality layer from a plurality of quality layers contained in each of spatial layers of the SVC bitstream; a layer discarding unit to discard the at least one quality layer; and a layer dependency modification unit to modify a quality layer dependency between one or more quality layers remaining among the plurality of quality layers, or a spatial layer dependency between the plurality of spatial layers. Accordingly, it is possible to adapt the SVC bitstream where the entire quality of spatial layers is enhanced.

### TECHNICAL FIELD

The present invention relates to a method and apparatus for adapting a scalable video coding (SVC) bitstream, and more particularly, to a method and apparatus for adapting a SVC bit stream that may enhance the entire quality of a plurality of spatial layers in a SVC bitstream containing the plurality of spatial layers.

### BACKGROUND ART

Scalable video coding (SVC) scheme is a promising video format for applications of multimedia communication. SVC format, which is extended from the latest advanced video coding (AVC) scheme, is appropriate to create a wide variety of bitrates with high compression efficiency. An original SVC bitstream can be easily truncated in different manners to meet various characteristics and variations of devices and connections.

The SVC scheme may adaptively satisfy various types of user demands and bandwidths of the network using at least one of spatial scalability, temporal scalability, and signal-to-noise ratio (SNR) scalability.

An SVC bitstream can be divided into network abstraction layer (NAL) units. The NAL units are attributed by some basic elements, including dependency_id, quality_id, temporal_id, and priority_id which are respectively the identifiers of a spatial layer, a quality layer, a temporal layer, and a priority layer.

The SNR scalability can be of two normative modes, Medium Granular Scalability (MGS) mode or Coarse Granular Scalability (CGS) mode. The SNR scalability can be also Fine Granular Scalability (FGS) mode which allows arbitrary truncation of an SNR enhancement NAL unit. However, in the final standard text, FGS is not included as a normative mode of SNR scalability.

In terms of coding mechanism, MGS is essentially the same as CGS. The main difference between CGS and MGS is the flexibility in discarding data to meet a bitrate constraint condition. Specifically, all the NAL units included in the same CGS layer must be either completely retained or completely discarded. Whereas, thanks to the special design of MGS high level syntax, NAL units of an MGS layer can be individually discarded. Especially, in the case of the MGS, coded data corresponding to a quantization step (equivalent to a CGS layer) can be fragmented into at most 15 layers (or sub-layers). A set of fragmented MGS layers corresponding to a quantization step is referred to as an MGS stack.

In order to enhance the entire quality of spatial layers provided by the adapted SVC bitstream, the NAL units contained in the plurality of spatial layers of the SVC bitstream must be discarded based on a particular bitrate.

FIG. 1 illustrates a structure of an access unit 100 of an SVC bitstream encoded according to an MGS scheme.

The access unit 100 denotes a basic unit of the SVC bitstream. The SVC bitstream includes a plurality of layers. Data of each of the layers include a NAL header. The NAL header stores information regarding in which layer the data is included.

Referring to FIG. 1, the access unit 100 contains two spatial layers 1100 and 1200.

MGS layers contained in each of the spatial layers 1100 and 1200 are identified by a spatial layer identifier dependency_id (hereinafter, D) and a quality layer identifier quality_id (hereinafter, Q).

Also, the spatial layer 1200 contains a base quality layer 1210 and an MGS stack 1220 that is a set of MGS layers 1221, 1222, and 1223 fragmented corresponding to a quantization step, and the spatial layer 1100 contains a base quality layer 1110 and two MGS stacks 1120 and 1130, each contain three quality layers, that is, the MGS layers 1121, 1122, and 1123, 1131, 1132, and 1133, and 1221, 1222, and 1223, respectively.

The spatial layer 1100 has a D value of ‘0’ and the spatial layer 1200 has a D value of ‘1’.

The base quality layer 1110 contained in the spatial layer 1100 has a Q value of ‘0’. The MGS layers 1121, 1122, 1123, 1131, 1132, and 1133 contained in the spatial layer 1100 have a Q value of ‘1’ to ‘6’ sequentially from a lower MGS layer.

Similarly, the base quality layer 1210 contained in the spatial layer 1200 has a Q value of ‘0’. The MGS layers 1221, 1222, and 1223 contained in the spatial layer 1200 has a Q value of ‘1’ to ‘3’ sequentially from a lower MGS layer.

Each of the lowest MGS layers 1121, 1131, and 1221 of the MGS stacks 1120, 1130, and 1220 may contain motion data and direct current (DC) coefficients of residual signal, and may also include a portion of alternative current (AC) coefficients of the residual signal. The remaining MGS layers 1122, 1123, 1132, 1133, 1222, and 1223 excluding the lowest MGS layers 1121, 1131, and 1221 may include AC coefficients of the residual signal.

The SVC bitstream need to strictly meet a layer dependency constraint that all the MGS layers(or layer representation) used for an interlayer prediction need to exist in a decoder.

For example, the MGS layer 1133 of which D is ‘0’ and Q is ‘6’ is required to decode the base quality layer 1121 of which D is ‘1’ and Q is ‘0’. However, when the MGS layer 1133 is discarded, a layer dependency between the spatial layer 1100 corresponding to a lower spatial layer and the spatial layer 1200 corresponding to a higher spatial layer is not satisfied. Therefore, the SVC bitstream becomes non-compliant.

Similarly, the MGS layer 1123 of which D is ‘0’ and Q is ‘3’ is required to decode the

MGS layer 1131 of which D is ‘0’ and Q is ‘4’, and the MGS layers 1132 and 1133 corresponding to higher layers of the MGS layer 1131. Therefore, when the MGS layer 1123 is discarded, the layer dependency is not satisfied and thus the SVC bitstream may be non-compliant.

When it is possible to discard a portion of MGS layers contained in a lower spatial layer, the range of supportable bitrates may be extended. Also, when it is possible to appropriately discard the portion of MGS layers contained in the lower spatial layer, the quality of the highest spatial layer may be enhanced.

### DISCLOSURE OF INVENTION

### Technical Problem

An aspect of the present invention provides a method and apparatus for adapting a scalable video coding (SVC) bitstream that may enhance the entire quality of spatial layers.

### Technical Solution

According to an aspect of the present invention, there is provided an apparatus for adapting a scalable video coding (SVC) bitstream, the apparatus including: a layer selection unit to select at least one quality layer from a plurality of quality layers contained in each of spatial layers of the SVC bitstream; a layer discarding unit to discard quality layers; and a layer dependency modification unit to modify a quality layer dependency between one or more quality layers remaining among the plurality of quality layers, or a spatial layer dependency between the plurality of spatial layers.

Here, each of the quality layers may be either a Medium Granular Scalability (MGS) layer or a motion-compensated Fine Granular Scalability (FGS) layer.

According to another aspect of the present invention, there is provided a method of adapting an SVC bitstream, the method including: selecting at least one quality layer from a plurality of quality layers contained in each of spatial layers of the SVC bitstream; discarding the at least one quality layer; and modifying a quality layer dependency between one or more quality layers remaining among the plurality of quality layers, or a spatial layer dependency between the plurality of spatial layers.

### BRIEF DESCRIPTION OF DRAWINGS

FIG. 1 illustrates a structure of an access unit of a scalable video coding (SVC) bitstream encoded according to the Medium Granular Scalability (MGS) scheme;

FIG. 2 is a block diagram illustrating a configuration of an apparatus for adapting an SVC bitstream according to an embodiment of the present invention;

FIG. 3 illustrates a pseudo code of an operation of a layer dependency modification unit according to an embodiment of the present invention;

FIG. 4 illustrates syntax of a Supplemental Enhancement Information (SEI) message according to an embodiment of the present invention;

FIG. 5 is a flowchart illustrating a method of adapting an SVC bitstream according to an embodiment of the present invention; and

FIG. 6 is a flowchart illustrating an operation of selecting at least one quality layer shown in FIG. 5.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

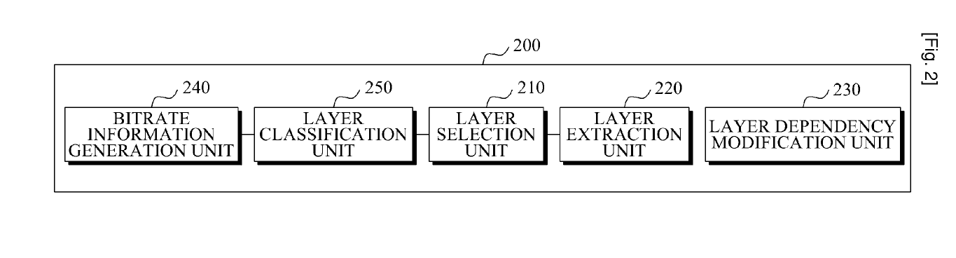

FIG. 2 is a block diagram illustrating a configuration of an apparatus 200 for adapting an SVC bitstream according to an embodiment of the present invention.

The SVC bitstream adaptation apparatus 200 may include a layer selection unit 210, a layer discarding unit 220, and a layer dependency modification unit 230. Here, the SVC bitstream adaptation apparatus 200 may further include a bitrate information generation unit 240 and a layer classification unit 250. Hereinafter, a function of each of constituent elements will be described in detail.

The layer selection unit 210 may select at least one quality layer from a plurality of quality layers contained in each of spatial layers of the SVC bitstream.

When quality layers contained in the highest spatial layer and quality layers contained in a lower spatial layer of the highest spatial layer are discarded, it is possible to extend the range of supportable bitrates in the SVC bitstream. The layer selection unit 210 functions to select the at least one quality layer to be discarded, with respect to all the spatial layers of the SVC bitstream.

According to an embodiment of the present invention, each of the quality layers may be either a Medium Granular Scalability (MGS) layer or a motion-compensated Fine granular Scalability (FGS) layer.

Specifically, the SVC bitstream adaptation apparatus 200 may be applicable to an MGS mode and a motion-compensated FGS mode.

As described above, according to an embodiment of the present invention, the SVC bitstream adaptation apparatus 200 may further include the bitrate information generation unit 240.

The bitrate information generation unit 240 may generate bitrate information about the plurality of spatial layers by analyzing the SVC bitstream.

In this case, the layer selection unit 210 may select the at least one quality layer based on the bitrate information.

Specifically, with the assumptions that the input SVC bitstream satisfies other constraint conditions such as a frame size, a frame rate, and the like, the SVC bitstream adaptation apparatus 200 may discard quality layers from each of spatial layers based on only a bitrate of the corresponding spatial layer.

Also, according to an embodiment of the present invention, the bitrate information may include a bitrate amount to be discarded. Specifically, the bitrate information may be a bitrate amount that is desired to be discarded.

As described above, according to an embodiment of the present invention, the SVC bitstream adaptation apparatus 200 may further include the layer classification unit 250.

The layer classification unit 250 may classify the plurality of quality layers into removable quality layers and non-removable quality layers.

In this case, the layer selection unit 210 may select the at least one quality layer from the removable quality layers.

Due to interlayer prediction between the spatial layers, a portion of the quality layers included in each of the spatial layers should not be discarded.

Therefore, in order to identify a quality layer that may not need to be discarded, the layer classification unit 250 may classify, into the removable quality layers and the non-removable quality layers, the plurality of quality layers included in each of the spatial layers. The layer selection unit 210 may select the at least one quality layer from the removable quality layers.

According to an embodiment of the present invention, the layer classification unit 250 may be included in the layer selection unit 210. In this case, the layer selection unit 210 may clearly select the removable quality layers and the non-removable quality layers.

Also, the layer classification unit 250 may analyze a network abstraction layer (NAL) header and slice header of a quality layer to thereby obtain information regarding whether the quality layer is removable, and may classify the quality layer based on the obtained information.

Specifically, the layer classification unit 250 may analyze information contained in the NAL header to verify whether a corresponding NAL unit is removable or non-removable, and may classify a corresponding quality layer based on the verification result.

According to an embodiment of the present invention, the layer classification unit 250 may classify, into the removable quality layers, a plurality of quality layers that are contained in the highest spatial layer among the plurality of spatial layers.

The quality layers contained in the highest spatial layer do not affect the interlayer prediction. Therefore, although the quality layers are discarded, a standard compliance may be maintained. The layer classification unit 250 may classify, into the removable quality layers, all the quality layers that contained in the highest spatial layer.

According to an embodiment of the present invention, the layer classification unit 250 may classify, into the removable quality layers, a quality layer that does not contain motion data, among a plurality of quality layers that are contained in a lower spatial layer of the highest spatial layer among the plurality of spatial layers.

In SVC, the motion data may be more important than the residual data. Therefore, when it is desired to discard a corresponding quality layer from a plurality of quality layers contained in another spatial layer excluding the highest spatial layer, the layer classification unit 250 may verify whether the plurality of quality layers contains the motion data.

Next, the layer classification unit 250 may classify a quality layer containing the motion data into the non-removable quality layer, and may classify a quality layer not containing the motion data into the removable quality layer.

The layer discarding unit 220 may discard the at least one quality layer.

The layer discarding unit 220 may discard the at least one quality layer from each of the spatial layers according to a certain discarding rule.

For example, the layer discarding unit 220 may discard a quality layer of a higher temporal layer and subsequently discard a quality layer of a next lower temporal layer.

As another example, separately from the certain discarding rule, a quality layer contained in the same spatial layer within the same access unit may need to be sequentially discarded in an order from the highest quality layer to the lowest quality layer.

The layer dependency modification unit 230 may modify a quality layer dependency between one or more quality layers remaining among the plurality of quality layers, or a spatial layer dependency between the plurality of spatial layers.

Specifically, the layer dependency modification unit 230 functions to modify a layer dependency between spatial layers or a layer dependency between quality layers, so that the standard compliance can be maintained even after the at least one quality layer is discarded.

According to an embodiment of the present invention, each of the quality layers may include a quality layer identifier. The layer dependency modification unit 230 may modify the quality layer dependency by changing the quality layer identifier, so that a difference of the quality layer identifier between adjacent quality layers among the one or more quality layers are uniform.

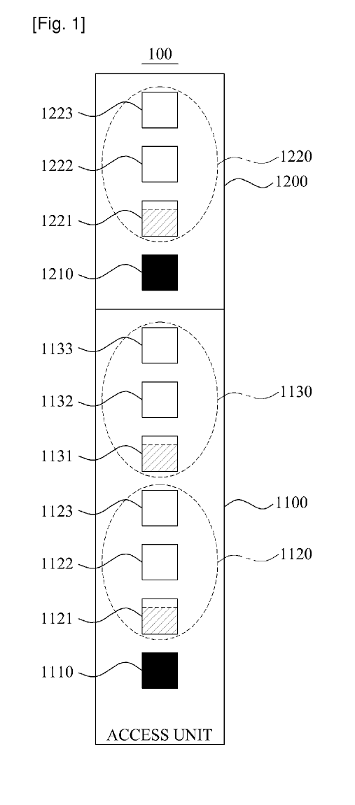

Specifically, as described above with reference to FIG. 1, each of the quality layers is identified by the spatial layer identifier and the quality layer identifier. In order to maintain the standard compliance, quality layer identifiers of the quality layers contained in the same spatial layer should have to have a consecutive value.

Accordingly, the layer dependency modification unit 230 functions to change the quality layer identifier of each of the remaining quality layers so that the quality layer identifier thereof have the consecutive value. Since a header of a NAL unit is not compressed, it is easy to change the quality layer identifier.

For example, referring to FIGS. 1 and 2, when the layer discarding unit 220 discards the quality layer 1123, the layer dependency modification unit 230 may change a quality layer identifier of the quality layer 1131 to ‘3’, a quality layer identifier of the quality layer 1132 to ‘4’, and a quality layer identifier of the quality layer 1133 to ‘5.

According to an embodiment of the present invention, each of the quality layers may include a quality layer identifier. The layer dependency modification unit 230 may modify the spatial layer dependency by controlling each of the spatial layers to refer to a quality layer identifier of the highest quality layer within a lower spatial layer that is adjacent to each of the spatial layers.

In order to perform the interlayer prediction, the highest quality layer of a lower spatial layer among two adjacent spatial layers may need to be referred to by the higher spatial layer. Therefore, the layer dependency modification unit 230 functions to control the highest spatial layer to refer to a quality layer identifier of the highest quality layer within the lower spatial layer.

For example, as described above, when the layer discarding unit 220 discards the quality layer 1123 whereby the quality layer identifier of the quality layer 1133 that is the highest quality layer of the spatial layer 1100 is changed to ‘5’, the layer dependency modification unit 230 may control the spatial layer 1200 to refer to the changed quality layer identifier ‘5’ of the quality layer 1133.

Hereinafter, an operation of a layer dependency modification unit according to an embodiment of the present invention will be described in detail.

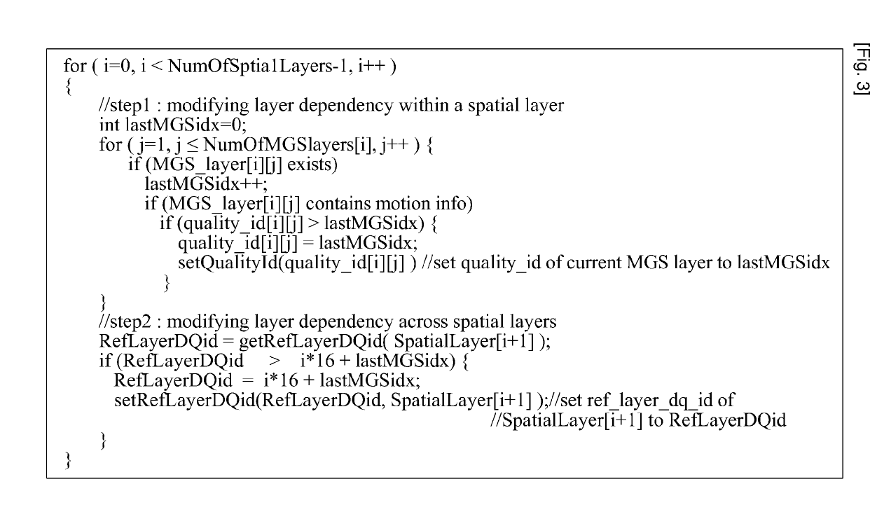

FIG. 3 illustrates a pseudo code of an operation of a layer dependency modification unit according to an embodiment of the present invention.

Here, it is assumed that a quality layer is an MGS layer.

Referring to FIG. 3, a main loop may start from the lowest spatial layer and be iteratively performed with respect to each of a plurality of spatial layers.

In FIG. 3, i denotes an order of a spatial layer and j denotes an order of the MGS layer. Also, it is possible that at least one MGS layer lower than a non-removable MGS layer, for example, an MGS layer containing motion data is discarded.

In the first step (step 1), the layer dependency modification unit may decrease quality_id of the non-removable MGS layer in order to maintain a continuity of quality_id that is a quality layer identifier within the same spatial layer. Also, in step 1, quality_id of the remaining highest MGS layer, that is, lastMGSidx may be recorded.

In a second step (step 2), the layer dependency modification unit may modify ref_layer_dq_id of a next highest spatial layer to make the highest MGS layer remaining within a lower spatial layer be referred to for an interlayer prediction.

Here, since ref layer_dq_id is encoded within a slice header, ref_layer_dq_id may be modified by parsing the slice header, modifying a value of ref_layer_dq_id, and encoding again the slice header. Also, when a context adaptive binary arithmetic coding (CABAC) scheme is used to encode slice data, an alignment bit between the slice header and the slice data may need to be modified. However, only one or two base quality layers are modified in a single access unit and thus a relatively less time may be used to perform the modification. The time for performing the above process has nothing to do with a picture size.

Hereinafter, the SVC adaptation apparatus 200 will be described with reference again to FIG. 2.

The layer classification unit 250 may classify the plurality of quality layers using a Supplemental Enhancement Information (SEI) message.

Specifically, information regarding whether the quality layer is removable may be obtained using the SEI message.

For example, when whether the MGS layer is removable is determined depending on whether motion data is contained, the SEI message may be used to indicate which MGS layers contain the motion data.

In this case, the SEI message may be generated by analyzing an MGS slice header so that the layer discarding unit 230 may verify whether the motion data is contained in MGS NAL units.

Also, only a single SEI message may be used to indicate the MGS layer containing the motion data. The SEI message is valid until the presence of the next SEI message.

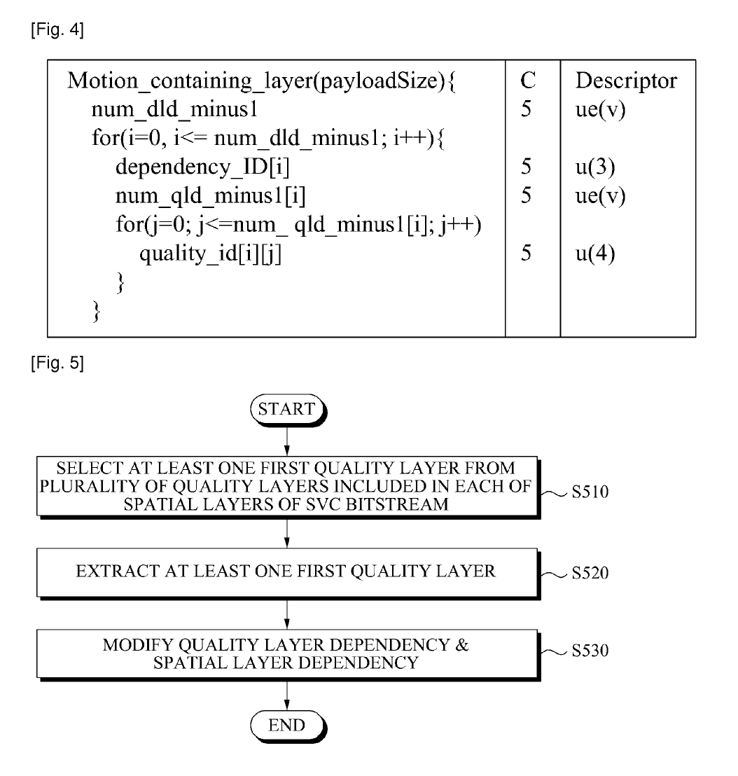

FIG. 4 illustrates syntax of a SEI message according to an embodiment of the present invention.

A motion-containing layer SEI message indicates MGS layers that contain motion data. The motion-containing layer SEI message may be valid until another motion-containing layer SEI message appears.

“num_dld_minus1+1” denotes the number of spatial layers(or dependency representation) that contain the MGS layer containing the motion data. Also, dependency_ID[i] denotes a spatial layer identifier of each of the spatial layers.

“num_qld_minus1[i]+1” denotes the number of MGS layers containing the motion data that exist in a spatial layer having the same value as dependency_ID[i]. Also, quality_id[i][j] denotes a quality layer identifier of the MGS layer.

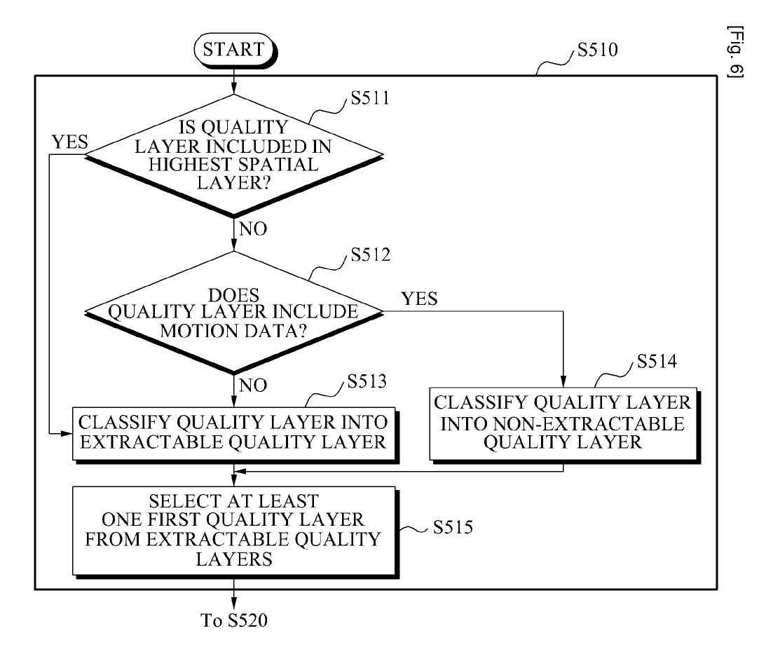

FIG. 5 is a flowchart illustrating a method of adapting an SVC bitstream according to an embodiment of the present invention, and FIG. 6 is a flowchart illustrating operation S510 of FIG. 5. Hereinafter, the SVC bitstream adapting method will be described in detail with reference to FIGS. 5 and 6.

In operation S510, the SVC bitstream adapting method may select at least one quality layer from a plurality of quality layers contained in each of spatial layers of the SVC bitstream.

According to an embodiment of the present invention, each of the quality layers may either an MGS layer or a motion-compensated FGS layer.

Although not shown in the figure, according to an embodiment of the present invention, the SVC bitstream adapting method may further include generating bitrate information about the plurality of spatial layers by analyzing the SVC bitstream. In this case, the SVC bitstream adapting method may select the at least one quality layer based on the bitrate information in operation S510.

Specifically, the SVC bitstream adapting method may discard the quality layer from each of the spatial layer by considering only a bitrate of the corresponding spatial layer.

Also, according to an embodiment of the present invention, the bitrate information may include a bitrate amount to be discarded. Specifically, the bitrate information may be a bitrate amount that is desired to be discarded.

Also, according to an embodiment of the present invention, the SVC adapting method may further include classifying the plurality of quality layers into removable quality layers and non-removable quality layers.

In this case, the SVC adapting method may select the at least one quality layer from the removable quality layers in operation S510.

According to an embodiment of the present invention, the classifying may classify, into the removable quality layers, a plurality of quality layers that are included in the highest spatial layer among the plurality of spatial layers.

Also, according to an embodiment of the present invention, the classifying may classify, into the removable quality layers, a quality layer that does not contain motion data, among a plurality of quality layers that are included in a lower spatial layer of the highest spatial layer among the plurality of spatial layers.

Hereinafter, operation S510 will be described in detail with reference to FIG. 6.

Here, it is assumed that the classifying of the plurality of quality layers is included in operation S510.

In operation S511, the SVC adapting method may determine whether a quality layer is included in the highest spatial layer.

When it is determined the quality layer is included in the highest spatial layer in operation S511, the SVC adapting method may classify, into removable quality layers, all the quality layers that are included in the highest spatial layer in operation S513.

Conversely, when it is determined the quality layer is not included in the highest spatial layer in operation S511, the SVC adapting method may determine whether the quality layer contains motion data in operation S512.

When it is determined the quality layer does not contain the motion data in operation S512, the SVC adapting method may classify the quality layer into the removable quality layer in operation S513. Conversely, when it is determined the quality layer contains the motion data in operation S513, the SVC adapting method may classify the quality layer into a non-removable quality layer in operation S514.

In operation S515, the SVC adapting method may select at least one quality layer from the removable quality layers.

Hereinafter, the SVC adapting method will be described with reference again to FIG. 5.

In operation S520, the SVC adapting method may discard the at least one quality layer.

Also, in operation S520, the SVC adapting method may discard the at least one quality layer from each of the spatial layers according to a particular discarding rule.

In operation S530, the SVC adapting method may modify a quality layer dependency between one or more quality layers remaining among the plurality of quality layers, or a spatial layer dependency between the plurality of spatial layers.

Specifically, in operation S530, the SVC adapting method may modify a layer dependency between spatial layers or a layer dependency between quality layers, so that the standard compliance is maintained even after the at least one quality layer is discarded.

According to an embodiment of the present invention, each of the quality layers may include a quality layer identifier. The SVC adapting method may modify the quality layer dependency by changing the quality layer identifier, so that a difference of the quality layer identifier between adjacent quality layers among the one or more quality layer is uniform in operation S530.

Also, according to an embodiment of the present invention, each of the quality layers may include a quality layer identifier. The SVC adapting method may modify the spatial layer dependency by controlling each of the spatial layers to refer to a quality layer identifier of the highest quality layer within a lower spatial layer that is adjacent to each of the spatial layers in operation S530.

Embodiments of the SVC adapting method according to the present invention have been described above. The SVC adapting apparatus described above with reference to FIG. 2 may be applicable to the embodiments. Further detailed description related thereto will be omitted here.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for adapting a scalable video coding (SVC) bitstream, the apparatus comprising: a layer selection unit to select at least one quality layer from a plurality of quality layers contained in each of spatial layers of the SVC bitstream; a layer discarding unit to discard the at least one quality layer; and a layer dependency modification unit to modify a quality layer dependency between one or more quality layers remaining among the plurality of quality layers, or a spatial layer dependency between the plurality of spatial layers.

2. The apparatus of claim 1, wherein: each of the quality layers can be either a Medium Granular Scalability (MGS) layer or a motion-compensated Fine Granular Scalability (FGS) layer.

3. The apparatus of claim 1, further comprising: a bitrate information generation unit to generate bitrate information about the plurality of spatial layers by analyzing the SVC bitstream, wherein the layer selection unit selects the at least one quality layer based on the bitrate information.

4. The apparatus of claim 3, wherein: the bitrate information includes a bitrate amount to be discarded.

5. The apparatus of claim 1, further comprising: a layer classification unit to classify the plurality of quality layers into removable quality layers and non-removable quality layers, wherein the layer selection unit selects the at least one quality layer from the removable quality layers.

6. The apparatus of claim 5, wherein: the layer classification unit classifies, into the removable quality layers, a plurality of quality layers that are contained in the highest spatial layer among the plurality of spatial layers.

7. The apparatus of claim 5, wherein: the layer classification unit classifies, into the removable quality layers, a quality layer that does not contain motion data, among a plurality of quality layers that are contained in a lower spatial layer of the highest spatial layer among the plurality of spatial layers.

8. The apparatus of claim 5, wherein the layer classification unit classifies the plurality of quality layers using a Supplemental Enhancement Information (SEI) message.

9. The apparatus of claim 1, wherein: each of the quality layers contains a quality layer identifier, and the layer dependency modification unit modifies the quality layer dependency by changing the quality layer identifier, so that the difference of the quality layer identifier between adjacent quality layers among the one or more quality layers are uniform.

10. The apparatus of claim 1, wherein: each of the quality layers includes a quality layer identifier, and the layer dependency modification unit modifies the spatial layer dependency by controlling each of the spatial layers to refer to a quality layer identifier of the highest quality layer within a lower spatial layer that is adjacent to each of the spatial layers.

11. A method of adapting an SVC bitstream, the method comprising: selecting at least one quality layer from a plurality of quality layers contained in each of spatial layers of the SVC bitstream; discarding the at least one quality layer; and modifying a quality layer dependency between one or more quality layers remaining among the plurality of quality layers, or a spatial layer dependency between the plurality of spatial layers.

12. The method of claim 11, wherein each of the quality layers can be either an MGC layer or a motion-compensated FGS layer.

13. The method of claim 11, further comprising: generating bitrate information about the plurality of spatial layers by analyzing the SVC bitstream, wherein the selecting of the at least one quality layer selects the at least one quality layer based on the bitrate information.

14. The method of claim 11, further comprising: classifying the plurality of quality layers into removable quality layers and non-removable quality layers, wherein the selecting of the at least one quality layer selects the at least one quality layer from the removable quality layers.

15. The method of claim 14, wherein: the classifying classifies, into the removable quality layers, the plurality of quality layers that are contained in the highest spatial layer among the plurality of spatial layers.

16. The method of claim 14, wherein: the classifying classifies, into the removable quality layers, a quality layer that does not contain motion data, among a plurality of quality layers that are contained in a lower spatial layer of the highest spatial layer among the plurality of spatial layers.

17. The method of claim 11, wherein: each of the quality layers contains a quality layer identifier, and the modifying modifies the quality layer dependency by changing the quality layer identifier, so that a difference of the quality layer identifier between adjacent quality layers among the one or more quality layers are uniform.

18. The method of claim 11, wherein: each of the quality layers includes a quality layer identifier, and the modifying modifies the spatial layer dependency by controlling each of the spatial layers to refer to a quality layer identifier of the highest quality layer within a lower spatial layer that is adjacent to each of the spatial layers.

19. A computer-readable recording medium storing a program for implementing the method of claim 11.
